(19) United States
(12) Patent Application Publication
(10) Pub. No.: US 2021/0067013 A1
(43) Pub. Date: Mar. 4, 2021

(54) AUXILIARY ASSEMBLY ELECTRIC MOTOR FOR A MOTOR VEHICLE

(71) Applicant: PIERBURG PUMP TECHNOLOGY GMBH, NEUSS (DE)

(72) Inventors: ANDREAS WULF, DUESSELDORF (DE); WOLFGANG PILENZ, NEUKIRCHEN-VLUYN (DE)

(73) Assignee: PIERBURG PUMP TECHNOLOGY GMBH, NEUSS (DE)

(21) Appl. No.: 16/960,091

(22) PCT Filed: Dec. 4, 2018
(86) PCT No.: PCT/EP2018/083484

§ 371 Date: Jul. 6, 2020

(30) Foreign Application Priority Data
Jan. 8, 2018 (DE) 10 2018 100 242.4

(51) Int. Cl. H02K 11/40; H02K 11/33; H02K 21/14

(52) U.S. Cl. CPC H02K 11/40; H02K 2211/03; H02K 21/14; H02K 11/33

(57) ABSTRACT

A motor vehicle auxiliary unit electric motor includes a permanent-magnetic motor rotor, a motor stator having a ferromagnetic stator body and at least one stator coil, a motor electronics unit which is electrically connected to and which drives the at least one stator coil, and a contact spring. The motor electronics unit has an external ground connector which electrically connects the motor electronics unit to an external vehicle ground, and an internal ground contact which is electrically connected to the external ground connector. The contact spring provides a direct electrical connection between the internal ground contact of the motor electronics unit and the ferromagnetic stator body.

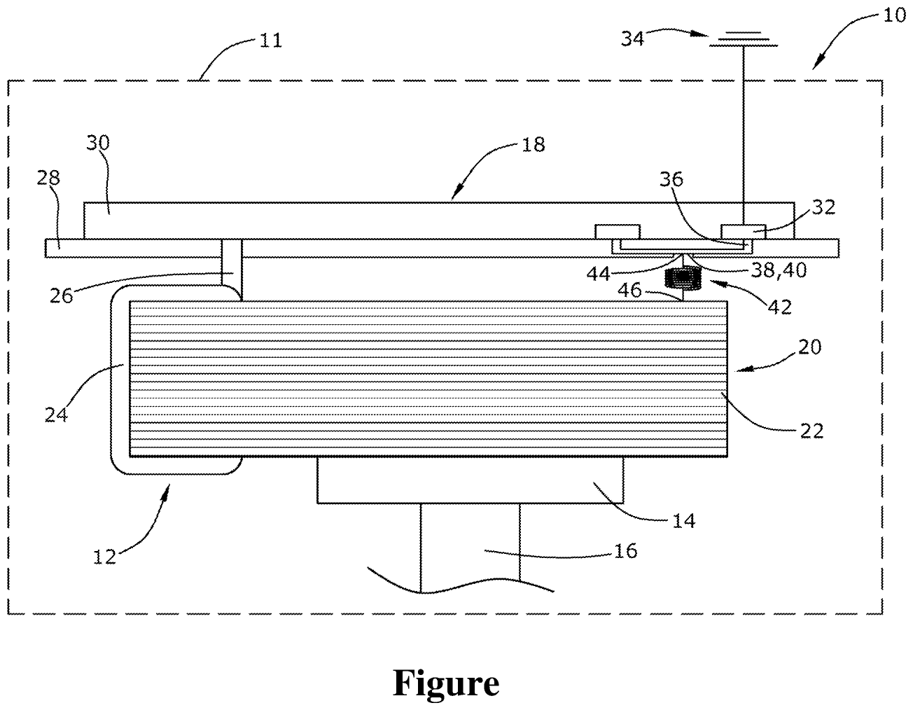

### CROSS REFERENCE TO PRIOR APPLICATIONS

This application is a U.S. National Phase application under 35 U.S.C. § 371 of International Application No. PCT/EP2018/083484, filed on Dec. 4, 2018 9and which claims benefit to German Patent Application No. 10 2018 100 242.4, filed on Jan. 8, 2018. The International Application was published in German on Jul. 11, 2019 as WO 2019/134779 A1 under PCT Article 21(2).

### FIELD

The present invention relates to a motor vehicle auxiliary unit electric motor, for example, to an electric gas pump of a motor vehicle.

### BACKGROUND

A motor vehicle auxiliary unit electric motor comprises a permanent-magnetic motor rotor, and a motor stator having a ferromagnetic stator body and at least one stator coil. The electric motor further comprises a motor electronics unit which is electrically connected to the stator coil for controlling the stator coil and thus driving the motor rotor. The motor electronics unit comprises an external ground connector for connecting the motor electronics unit to an external vehicle ground.

Like all electronic devices, electric motors emit stray electromagnetic radiation which may cause the malfunction or failure of electronic devices in the vicinity of the electric motor. The motor control electronics for a motor vehicle can, for example, suffer from interference. Electronic devices must therefore comply with application-specific guidelines with regard to electromagnetic compatibility (EMC).

### SUMMARY

An aspect of the present invention is to provide a motor vehicle auxiliary unit electric motor which has constantly good EMC properties.

In an embodiment, the present invention provides a motor vehicle auxiliary unit electric motor which includes a permanent-magnetic motor rotor, a motor stator comprising a ferromagnetic stator body and at least one stator coil, a motor electronics unit which is electrically connected to and which is configured to drive the at least one stator coil, and a contact spring. The motor electronics unit comprises an external ground connector which is configured to electrically connect the motor electronics unit to an external vehicle ground, and an internal ground contact which is electrically connected to the external ground connector. The contact spring is configured to provide a direct electrical connection between the internal ground contact of the motor electronics unit and the ferromagnetic stator body.

### BRIEF DESCRIPTION OF THE DRAWING

The present invention is described in greater detail below on the basis of embodiments and of the drawing in which:

The Figure shows a schematic side view of an auxiliary unit electric motor of a motor vehicle.

### DETAILED DESCRIPTION

The motor vehicle auxiliary unit electric motor according to the present invention comprises a permanent-magnetic motor rotor, and a motor stator having a ferromagnetic stator body and at least one stator coil. The motor rotor can, for example, be a ferromagnetic rotor body having a separate permanent magnet. The motor rotor can alternatively comprise a monolithic permanent-magnetic rotor body.

The motor vehicle auxiliary unit electric motor comprises an motor electronics unit which is electrically connected to the stator coil for controlling the stator coil and thus driving the motor rotor. The motor electronics comprises a plurality of power semiconductors for commutating the electrical energy for controlling the stator coil. The motor electronics unit is electrically connected to an external vehicle ground via an external ground connector in order to provide an energy supply of the motor electronics unit. The motor electronics unit further comprises an internal ground contact which is directly electrically connected to the external ground connector via a low-resistance electrical connection.

The motor vehicle auxiliary unit electric motor comprises a contact spring which provides a direct low-resistance electrical connection between the stator body and the internal ground contact of the motor electronics unit and thus the vehicle ground. The stator body can thereby serve as an electromagnetic shield, whereby the emitted electromagnetic radiation of the electric motor is drastically reduced and, consequently, the EMC properties of the electric motor are considerably improved. The motor vehicle auxiliary unit electric motor in particular reliably and permanently provides good EMC properties even when an electrically insulating plastic housing is used which cannot serve as an electric shield, and even at high motor rotational speeds at which the electromagnetic stray radiation is particularly high.

Due to the mechanical flexibility of the contact spring, axial movements between the motor electronics unit and the stator body can in particular be balanced, whereby an interruption of the electrical connection between the internal ground contact and the stator body due to a tearing of a solder connection, shocks acting on the electric motor, or vibrations in the electric motor can, for example, be prevented. The mechanically flexible contact spring according to the present invention thus provides a particularly reliable electrical connection between the internal ground contact and the stator body.

In an embodiment of the present invention, the stator body of the motor stator can, for example, be made from a stack of sheet plates, whereby eddy currents in the stator body are minimized. This provides a high efficiency of the electric motor. The individual sheet plates of the stack of sheet plates are here electrically connected to each other, for example, via a form-fit connection through corresponding punched sections.

In an embodiment of the present invention, the stator can, for example, comprise only one stator coil. This provides a very compact and inexpensive design of the electric motor.

In an embodiment of the present invention, the contact spring can, for example, be a helical spring having a high flexibility in both the axial and in the radial direction, and thus can compensate for both axial and radial displacement between the internal ground contact and the stator body. This provides a particularly reliable and permanent electrical connection between the internal ground contact and the stator body.

In an embodiment of the present invention, the motor electronics can, for example, comprise a circuit board on which the internal ground contact is arranged. The circuit board provides a particularly simple arrangement of the electronics. The circuit board can, for example, be made from a fiber-reinforced plastic material and comprises conductor paths for electrically connecting the individual electronic components.

In an embodiment of the present invention, the internal ground contact can, for example, be realized by a non-insulated circuit board region of the circuit board which is directly electrically connected to external ground connector. This provides a simple and inexpensive design of the internal ground contact where no additional contact elements must be provided.

In an embodiment of the present invention, the contact spring can, for example, be attached to the circuit board by a solder connection and is merely in a touching contact with the stator body. This allows for a very simple installation of the contact spring. The one-sided attachment of the contact spring can also prevent a stress-induced mechanical damage of the contact spring or its attachment. A reliable electrical connection between the internal ground contact and the stator body can be provided via a suitable axial biasing of the contact spring despite the one-sided attachment.

An exemplary embodiment of the present invention is described below under reference to the accompanying Figure which shows a schematic side view of an auxiliary unit electric motor of a motor vehicle.

The Figure shows a motor vehicle auxiliary unit electric motor 10 for use, for example, in a degasifying pump of a motor vehicle fuel tank. Such degasifying pumps are operated at rotational speeds of more than 10,000 rpm and thus tend to generate particularly strong stray electromagnetic radiation.

The motor vehicle auxiliary unit electric motor 10 comprises a housing 11 which, in the present embodiment, is made from an electrically insulating plastic material, a motor stator 12, a permanent-magnetic motor rotor 14 having a rotor shaft 16, and a motor electronics unit 18.

The motor stator 12 comprises a stator body 20 composed of a stack of sheet plates defined by a plurality of electrically interconnected ferromagnetic sheet plates 22, and comprises only one stator coil 24.

The motor electronics unit 18 comprises a circuit board 28 on which a motor electronics 30 is arranged. The motor electronics 30 is electrically connected to the stator coil 24 via a connecting element 26 for controlling the stator coil 24 and thus drive the permanent-magnetic motor rotor 14. The motor electronics unit 18 comprises an external ground connector 32 which is electrically connected to an external vehicle ground 34. The circuit board 28 comprises a conductor path 36 which electrically connects the external ground connector 32 to the motor electronics 30. The circuit board 28 comprises a non-insulated conductor path region 38 on the conductor path 36, which defines an internal ground contact 40 of the motor electronics unit 18.

The internal ground contact 40 is electrically connected to the stator body 20 via a contact spring 42 which, in the present embodiment, is a helical spring made from a material having a high electric conductivity. The contact spring 42 is attached to the internal ground contact 40 via its first axial contact spring end 44, for example, via a solder connection, while its opposing second axial contact spring end 46 contacts the stator body 20. The contact spring 42 is axially biased in order to be able to balance both axial and radial displacement between the stator body 20 and the motor electronics unit 18 and thus provide a reliable electrical connection between the internal ground contact 40 and the stator body 20. The one-sided attachment of the contact spring 42 also avoids mechanical damage of the contact spring 42 or its attachment even in the case of a large displacement between the stator body 20 and the motor electronics unit 18.

The contact spring 42 provides an electrical potential equalization between the stator body 20 and the internal ground contact 40 and thus a potential equalization between the stator body 20 and the external vehicle ground 34. The stator body 20 can thereby serve as an electromagnetic shield, whereby the EMC properties of the motor vehicle auxiliary unit electric motor 10 are considerably improved.

The present invention is not limited to embodiments described herein; reference should be had to the appended claims.

### LIST OF REFERENCE NUMERALS

10 Motor vehicle auxiliary unit electric motor

11 Housing

12 Motor stator

14 Permanent-magnetic motor rotor

16 Rotor shaft

18 Motor electronics unit

20 Stator body

22 Ferromagnetic sheet plates

24 Stator coil

26 Connecting element

28 Circuit board

30 Motor electronics

32 External ground connector

34 External vehicle ground

36 Conductor path

38 Non-insulated circuit board region

40 Internal ground contact

42 Contact spring

44 First axial contact spring end

46 Second axial contact spring end

What is claimed is:

1-7. (canceled)

8. A motor vehicle auxiliary unit electric motor comprising:
a permanent-magnetic motor rotor;
a motor stator comprising a ferromagnetic stator body and at least one stator coil;
a motor electronics unit which is electrically connected to and which is configured to drive the at least one stator coil, the motor electronics unit comprising,
an external ground connector which is configured to electrically connect the motor electronics unit to an external vehicle ground, and
an internal ground contact which is electrically connected to the external ground connector; and
a contact spring which is configured to provide a direct electrical connection between the internal ground contact of the motor electronics unit and the ferromagnetic stator body.

9. The motor vehicle auxiliary unit electric motor as recited in claim 8, wherein the ferromagnetic stator body comprises a stack of sheet plates.

10. The motor vehicle auxiliary unit electric motor as recited in claim 8, wherein the at least one stator coil consists of a single stator coil.

11. The motor vehicle auxiliary unit electric motor as recited in claim 8, wherein the contact spring is a helical spring.

12. The motor vehicle auxiliary unit electric motor as recited in claim 8, wherein,
the motor electronics unit further comprises a circuit board, and
the internal ground contact is arranged on the circuit board.

13. The motor vehicle auxiliary unit electric motor as recited in claim 12, wherein the internal ground contact comprises a non-insulated conductor path region of the circuit board.

14. The motor vehicle auxiliary unit electric motor as recited in claim 12, wherein the contact spring is attached to the circuit board and is in a touching contact with the ferromagnetic stator body.
